(19) United States
(12) Patent Application Publication
(10) Pub. No.: US 2007/0088770 A1
(43) Pub. Date: Apr. 19, 2007

(54) Structure for re-arranging file allocation index by memory block

(76) Inventor: Ming-Tsung Chiang, Taipei County (TW)

Correspondence Address: HARNESS, DICKEY & PIERCE, P.L.C., P.O. BOX 8910, RESTON, VA, 20195, US

(21) Appl. No.: 11/249,394

(22) Filed: Oct. 14, 2005

(51) Int. Cl. G06F 17/30

(52) U.S. Cl. 707/205

(57) ABSTRACT

A structure for re-arranging file allocation index by a memory block, which comprises: at least one retained sector; a double file allocation table, for encrypting each file allocation table entry and a corresponding cluster with an encryption method, and hiding the encrypted index file into a reserved item; a root, for emptying a file entry records; a data area, for storing the file entry records, the file allocation table entry, and the corresponding cluster according to a storage path of the index file; and a master boot sector, for storing an encryption record of the encryption method.

### BACKGROUND OF THE INVENTION

1. Field of Invention

The present invention relates to a structure for re-arranging file allocation index, and more particular, to a structure for re-arranging file allocation index by a memory block.

2. Related Art

Generally, since the data arrangements in a plug-and-play storage device (e.g., SD card) have a standard format, the data can be read by all the card-reading apparatus with different brands. Due to the small size and convenience of the plug-and-play storage device, it usually acts as a storage medium for private-used small electronic products, such as a cell phone, a PDA, and a digital camera. However, since these electronic products are typically used for storing private data, when a plug-and-play storage device is lost by careless or stolen by others, the data stored therein are easily read by any one with a card-reading apparatus. Accordingly, although the plug-and-play storage device is convenient, the standardized format prevents the personal privacy from being protected.

The structure of raw data stored in a storage device is shown in FIG. 1. The memory block thereof comprises a master boot sector 10, a first retained sector 20, a secondary boot sector 30, a second retained sector 40, a first file allocation table 50, a second file allocation table 60, a root 70, and a data area 80. Therefore, how to make the storage device be more confidential when used for storing the raw data has become a hot issue.

### SUMMARY OF THE INVENTION

In view of the above-mentioned problems, the main object of the present invention is to provide a structure for re-arranging file allocation index by a memory block, which comprises: at least one retained sector; a double file allocation table, for encrypting each file allocation table entry and a corresponding cluster with a first encryption method, and hiding the encrypted index file into a reserved item; a root, for emptying the file entry records; a data area, for storing the file entry records, the file allocation table entry, and the corresponding cluster according to a storage path of the index file; and a master boot sector, for storing a first encryption record of the first encryption method.

The present invention may further encrypt the file entry records, the file allocation table entry, and the corresponding cluster with a second encryption method, and store them into the data area, so as to make the raw data more confidential.

The structure for re-arranging file allocation index by a memory block according to the present invention can be used for any storage devices with same file system (FAT), such as a hard disk or a plug-and-play storage device, wherein the plug-and-play storage device supports various memory card formats, which are currently available, e.g., CF, MicroDrive (Type I, Type II), SM, MMC, SD, MS, MS Pro, but it is not intended to limit the application scope of the present invention.

The detailed features and advantages of the present invention will be described in great detail in the embodiments, and the contents thereof are sufficient to enable those skilled in the art to appreciate the technology of the invention and to practice accordingly. And any advantages and objects related to the present invention can be readily understood from the contents disclosed in the specification, the claims, and the accompanying drawings.

The above illustration related to the contents of the present invention and the following illustration of the embodiments are used for exemplifying and explaining the principle of the present invention, and also for providing a further explanation about the claims of the present invention.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, and thus are not limitative of the present invention, and wherein:

FIG. 1 is a schematic view of a structure of a conventional memory block;

FIG. 2 is a schematic view of a structure for re-arranging file allocation index by a memory block according to the present invention;

FIG. 3A is a schematic view of a structure before a double file allocation table of a memory block is encrypted;

FIG. 3B is a schematic view of a structure after a double file allocation table of a memory block is encrypted;

FIG. 4A is a schematic view of a structure before a root of a memory block is encrypted;

FIG. 4B is a schematic view of a structure after a root of a memory block is encrypted;

FIG. 5A is a schematic view of a structure before a data area of a memory block is encrypted; and

FIG. 5B is a schematic view of a structure after a data area of a memory block is encrypted.

### DETAILED DESCRIPTION OF THE INVENTION

The features and practice of the present invention are now described below in the preferred embodiments with reference to the accompanying drawings.

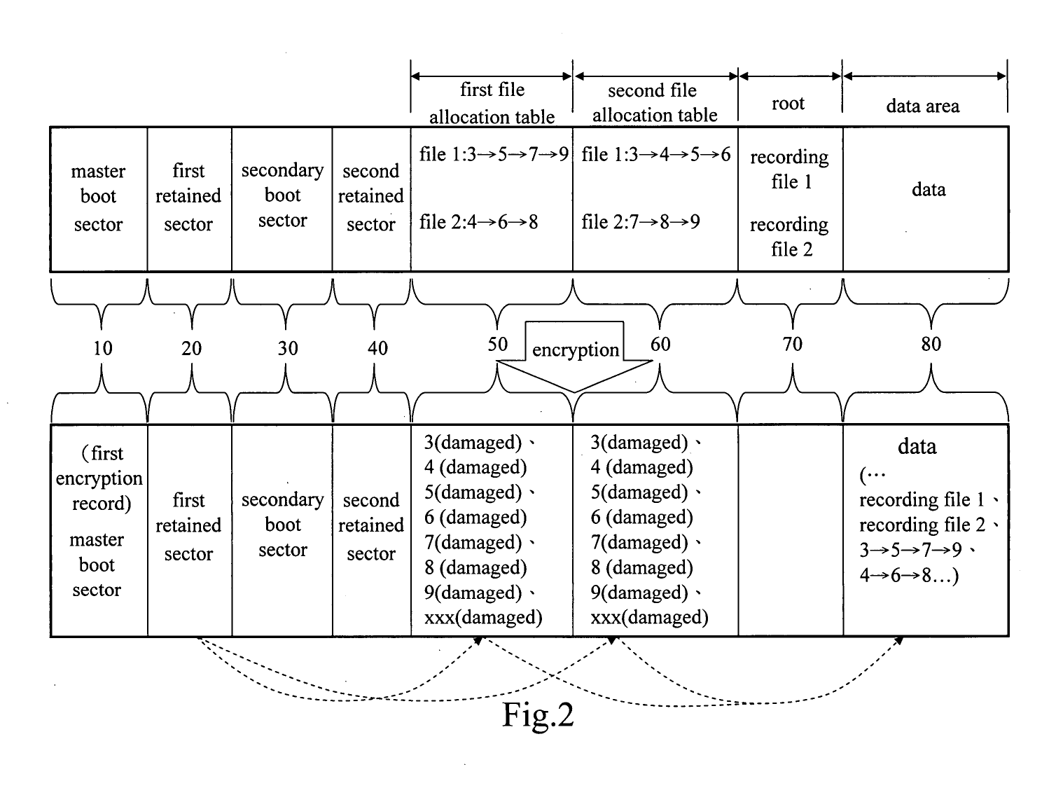

The present invention discloses a structure for re-arranging file allocation index by a memory block. Referring to FIG. 2, it is illustrated below by taking a plug-and-play storage device as an example: the original data connections of the file allocation table (FAT) on the structure of the plug-and-play storage device are particularly processed, thus resulting in an empty directory state; whereas the raw data are recorded in a damaged way, such that an ordinary card-reading system cannot read the file names or the connections of the raw data. As for the original FAT system, when it is not encrypted and also has data, file 1 and file 2 are used for recording the connections of the data block, whereas the root is used for describing the file contents, such as file name and length. However, after it is encrypted, the data-connecting blocks for file 1 and file 2 are all labeled with being damaged, and the root block is also emptied. But there is one more damaged block xxx added into the FAT. Actually, said damaged block is normally operated, for recording the raw data connections and the file descriptions, whereas some related information being encrypted, such as password and the record position of the raw data, are recorded into the area of the master boot sector (MBR) which hasn't been used by the system.

The encrypted file data cannot be read by an ordinary card reader, and the rest space of the encrypted plug-and-play storage device still can be used as storage space for the ordinary card readers or other electronic devices for reading memory cards. And the non-encrypted data may be incorporated with the encrypted data. When the plug-and-play storage device is encrypted, practically if it matches with, e.g., a SIM card and a cell phone, said encrypted data may be opened (read) by choosing one of them (a SIM card or a cell phone).

The present invention provides a preferred embodiment illustrated as follows:

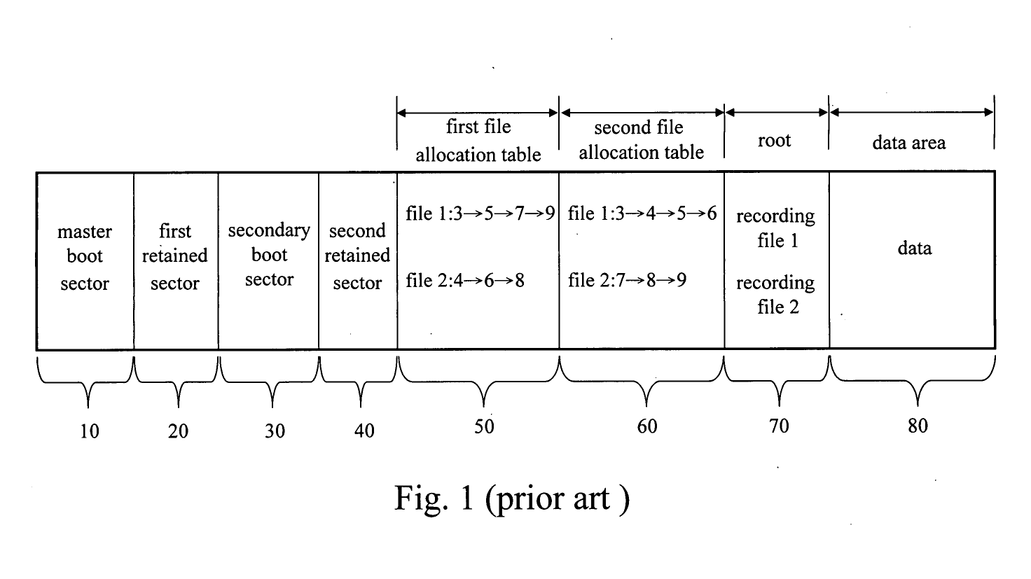

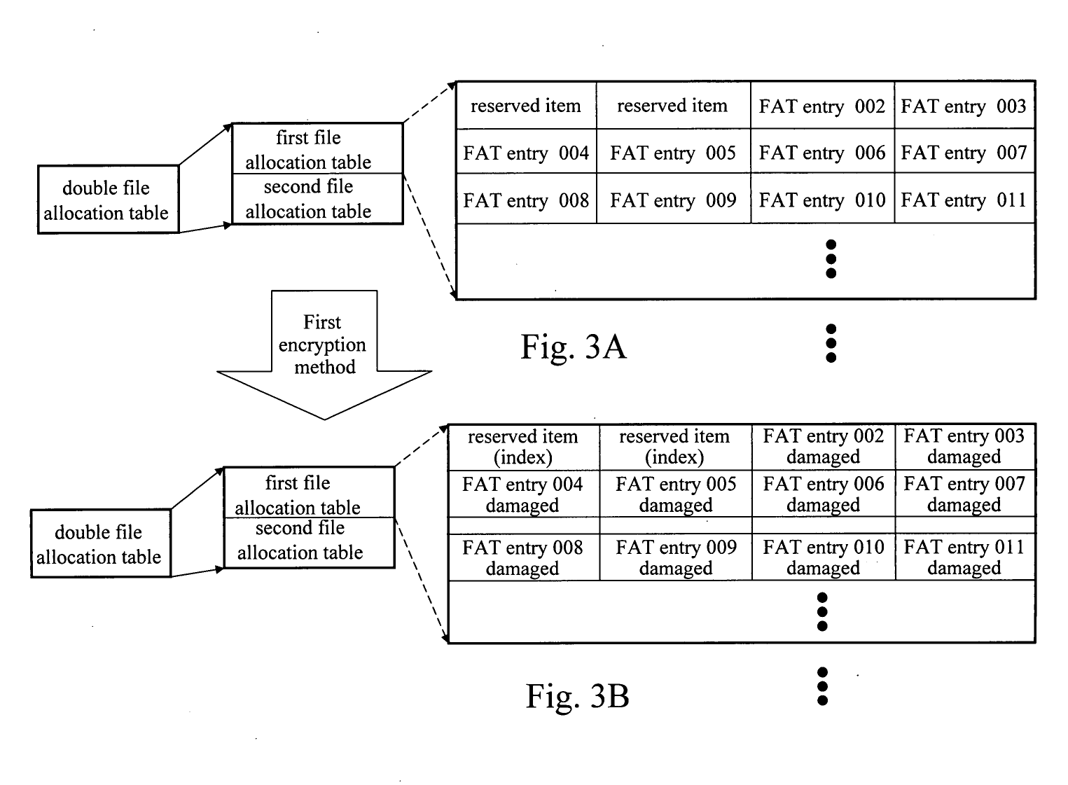

Referring to FIG. 3A, it is a schematic view of a structure before a double file allocation table of a memory block is encrypted. The so-called double file allocation table (FAT) is consisted of two FATs that meet the 9293 Standard of the International Organization for Standardization/International Electrotechnical Commission (ISO/IEC). Each of the FATs includes several file allocation table entries (FAT entry), wherein each FAT entry is connected to one cluster. Each FAT entry indicates whether the corresponding cluster has been used or not, if said cluster is not used, the FAT entry is set as not being used; and if said cluster has ever been used, the FAT entry is set to a cluster number. Said cluster number indicates the connection towards a next cluster to be read, which is immediately adjacent to said cluster, e.g., 3→5→7→9, as shown in FIG. 1, and the number attached to each FAT entry represents the number of the corresponding cluster.

Referring to FIG. 3B, it is a schematic view of a structure after a double file allocation table of a memory block is encrypted. Wherein each FAT entry and the corresponding cluster are encrypted with a first encryption method, and the encrypted index file is hidden into a reserved item.

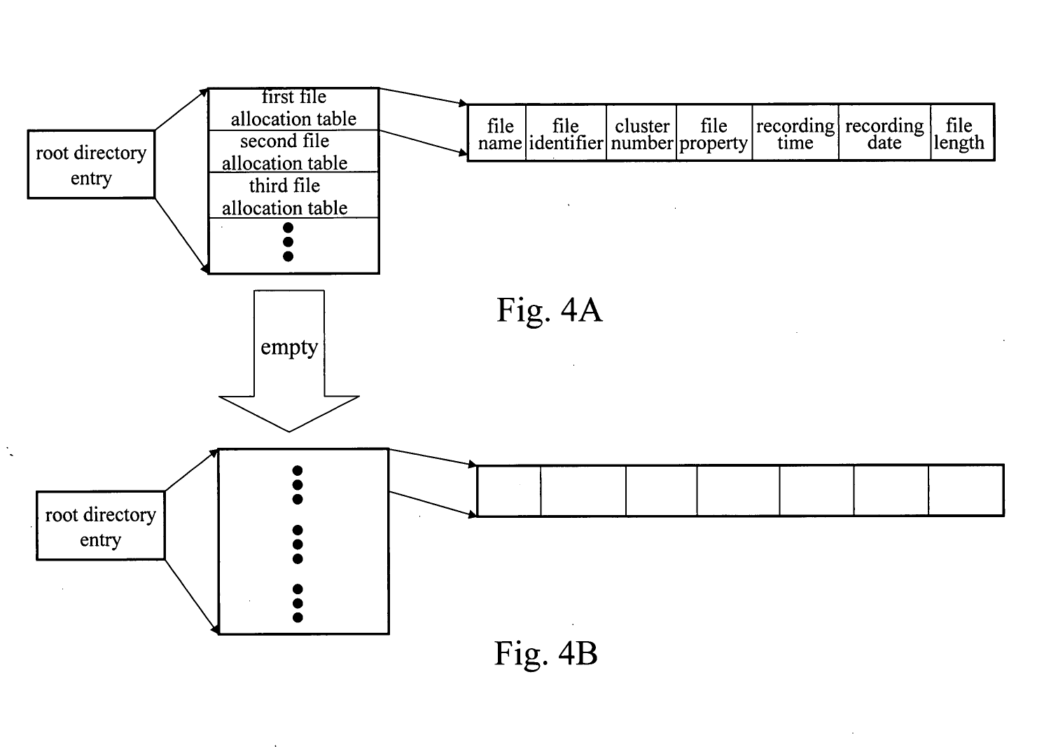

Referring to FIG. 4A, it is a schematic view of a structure before a root of a memory block is encrypted. There are multiple root directory entries under the root, wherein said root directory entry includes multiple file entries. Corresponding to the multiple files in the bootstrap directory, each file entry records comprises: a file name, a file identifier, a cluster number stored in the starting point of the file, a file property, a recording time, a recording date, a file length, etc.

Referring to FIG. 4B, it is a schematic view of a structure after a root of a memory block is encrypted. The file entry records is emptied according to the encryption method mentioned in the present invention.

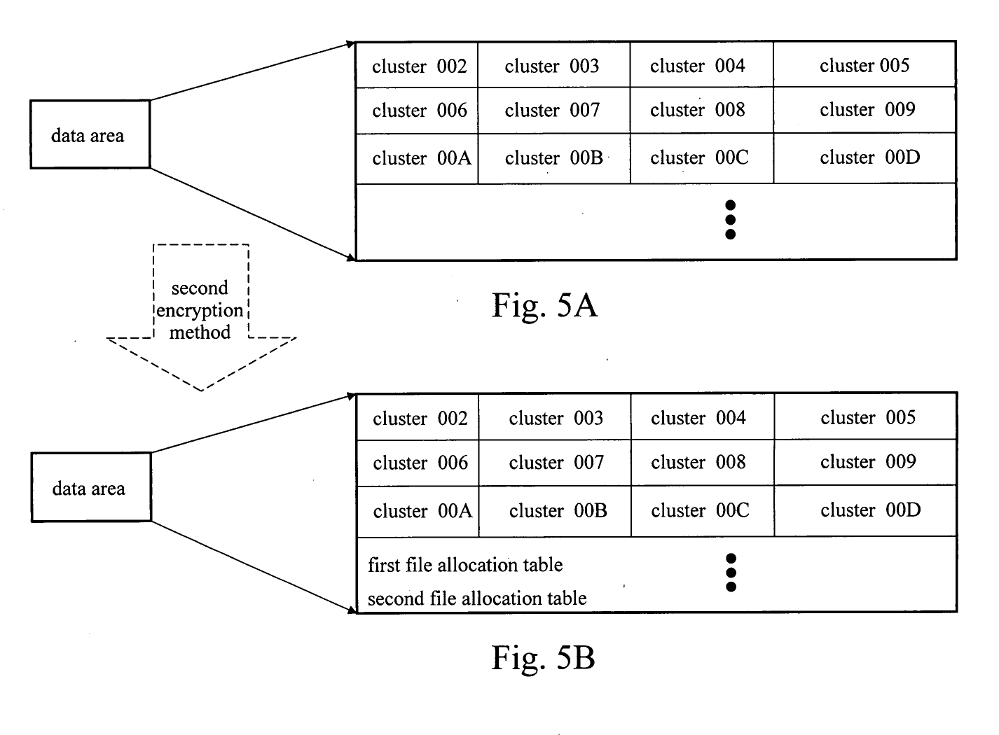

Referring to FIG. 5A, it is a schematic view of a structure before a data area of a memory block is encrypted; wherein a user's data is stored, which is usually called a data area.

Referring to FIG. 5B, it is a schematic view of a structure after a data area of a memory block is encrypted. Wherein, the file entry records, the FAT entry, and the corresponding cluster are stored according to the storage path of the index file.

The master boot sector stores the first encryption record (e.g., password) of the first encryption method.

Another preferred embodiment of the present invention may encrypt the file entry records, the FAT entry, and the corresponding cluster with a second encryption method, and store them into the data area, so as to make the raw data more confidential. Thus, by using this method, the master boot sector is further required to store a second encryption record of the second encryption method.

The first or second encryption method mentioned-above can be any encryption algorithm method, but it is not limited to a particular one. As for practical use, a specific machine code (e.g., IMEI code) or a SIM card (e.g., IMSI code) can be used as a unique secret key, to carry out a confidential protection for the raw data.

The structure for re-arranging file allocation index by a memory block according to the present invention can be used for any storage devices with same file system (FAT), such as a hard disk or a plug-and-play storage device, wherein the plug-and-play storage device supports various memory card formats, which are currently available, e.g., CF, MicroDrive (Type I, Type II), SM, MMC, SD, MS, MS Pro, but it is not intended to limit the application scope of the present invention.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A structure for re-arranging file allocation index by a memory block, comprising:
at least one retained sector;
a double file allocation table, storing damaged FAT entries and corresponding clusters wherein each of original FAT entries and corresponding clusters of the double file allocation table are encrypted and an encrypted index file is hidden into a reserved item;
a root for emptying file entry records;
a data area, storing the file entry records, the FAT entries, and the corresponding clusters, according to a storage path of the index file; and
a master boot sector, storing an encryption record of the encryption method.

2. The structure for re-arranging file allocation index by a memory block according to claim 1, further comprising a secondary boot sector.

3. The structure for re-arranging file allocation index by a memory block according to claim 1, wherein the double file allocation table comprises a first file allocation table and a second file allocation table.

4. The structure for re-arranging file allocation index by a memory block according to claim 1, wherein it is useful for a hard disk or a plug-and-play storage device.

5. The structure for re-arranging file allocation index by a memory block according to claim 1, wherein the secret key for the encryption method is a machine code.

6. The structure for re-arranging file allocation index by a memory block according to claim 1, wherein the secret key for the encryption method is a SIM card.

7. A structure for re-arranging file allocation index by a memory block, comprising:
at least one retained sector;
a double file allocation table, storing damaged FAT entries and corresponding clusters wherein each of original FAT entries and corresponding clusters of the double file allocation table are encrypted with a first encryption method and an encrypted index file is hidden into a reserved item;
a root for emptying a file entry records;
a data area, storing the file entry records, the FAT entries, and the corresponding cluster with a second encryption method, according to a storage path of the index file; and
a master boot sector, storing a first encryption record of the first encryption method and a second encryption record of the second encryption method.

8. The structure for re-arranging file allocation index by a memory block according to claim 7, wherein it further comprising a secondary boot sector.

9. The structure for re-arranging file allocation index by a memory block according to claim 7, wherein the double file allocation table comprises a first file allocation table and a second file allocation table.

10. The structure for re-arranging file allocation index by a memory block according to claim 7, wherein it is useful for a hard disk or a plug-and-play storage device.

11. The structure for re-arranging file allocation index by a memory block according to claim 7, wherein the secret key for the first encryption method is a machine code.

12. The structure for re-arranging file allocation index by a memory block according to claim 7, wherein the secret key for the first encryption method is a SIM card.
